(19) United States
(12) Patent Application Publication
(10) Pub. No.: US 2020/0198568 A1
(43) Pub. Date: Jun. 25, 2020

(54) AIRBAG DEVICE

(71) Applicant: JOYSON SAFETY SYSTEMS JAPAN K.K., Tokyo (JP)

(72) Inventors: Keisuke ONOHARA, Shiga (JP); Hidetomo OKA, Shiga (JP); Hiroki TAKEHARA, Shiga (JP)

(73) Assignee: JOYSON SAFETY SYSTEMS JAPAN K.K., Tokyo (JP)

(21) Appl. No.: 16/665,705

(22) Filed: Oct. 28, 2019

(30) Foreign Application Priority Data
Dec. 25, 2018 (JP) 2018-241272

(51) Int. Cl. B60R 21/201

(52) U.S. Cl. CPC B60R 21/201; B60R 21/237

(57) ABSTRACT

An airbag device includes: an airbag that is folded in normal times and is inflated and deployed in emergency situations; an inflator that supplies a gas to the airbag; a retainer that supports the airbag and the inflator; a module cover that has a plate-like section and a side wall section provided upright on the plate-like section, wherein a hook formed on the retainer is retained in an opening formed in the side wall section; and a first protector cloth that is retained in the hook, and covers an upper surface of a folded body of the airbag to maintain a folded shape of the airbag.

### CROSS-REFERENCE TO RELATED PATENT APPLICATION

The present invention is based upon and claims the benefit of priority from Japanese Patent Application No. 2018-241272, filed on Dec. 25, 2018, the entire contents of which are incorporated herein by reference.

### TECHNICAL FIELD

The present invention relates to an airbag device.

### BACKGROUND ART

It is becoming more common that in a vehicle, such as an automobile, an airbag device is mounted for absorbing impact to a passenger in emergency situations, such as an occurrence of a collision, by inflating and deploying an airbag in the vehicle. In general, the airbag device has an airbag that is folded in normal times and is inflated and deployed in emergency situations, an inflator that supplies a gas to the airbag, a retainer that supports the airbag and the inflator, and a module cover that covers the airbag. In emergency situations, such as an occurrence of a vehicle collision, a gas is supplied to the airbag from the inflator to inflate the airbag, the module cover is teared, and the airbag is released into the vehicle and inflated and deployed.

Conventionally, the folded airbag is covered by a protector cloth (packing cloth), and the folded shape is maintained. The ends of the protector cloth along with the airbag are fixed to the retainer using a fixing member (for example, a bag ring) for fixing the airbag to the retainer. For example, the protector cloth is fixed by inserting four bolts provided projecting from the bag ring into two openings provided in one end of the protector cloth and two openings provided in the other end.

[PTL 1] Japanese Patent No. 5926633

### SUMMARY OF INVENTION

It is an object of the present invention to provide an airbag device capable of firmly fixing a protector cloth to a retainer, and maintaining a folded shape of the airbag.

An airbag device of the present invention includes: an airbag that is folded in normal times and is inflated and deployed in emergency situations; an inflator that supplies a gas to the airbag; a retainer that supports the airbag and the inflator; a module cover that has a plate-like section and a side wall section provided upright on the plate-like section, wherein a hook formed on the retainer is retained in an opening formed in the side wall section; and a first protector cloth that is retained in the hook, and covers an upper surface of a folded body of the airbag to maintain a folded shape of the airbag.

In an aspect of the present invention, the airbag device further includes a second protector cloth that has both ends fixed to a bottom surface of the retainer along with the airbag, and envelops the folded body of the airbag to maintain the folded shape.

In the present invention, the protector cloth is retained in the hook of the retainer, thus it is possible to firmly fix the protector cloth to the retainer and maintain the folded shape of the airbag.

### BRIEF DESCRIPTION OF DRAWINGS

FIG. 1 is a cross-sectional view illustrating an airbag device according to an embodiment of the present invention.

FIG. 2 is a plan view of a protector cloth.

FIG. 3 is a vertical cross-sectional view taken along line III-III of FIG. 2.

### DESCRIPTION OF EMBODIMENTS

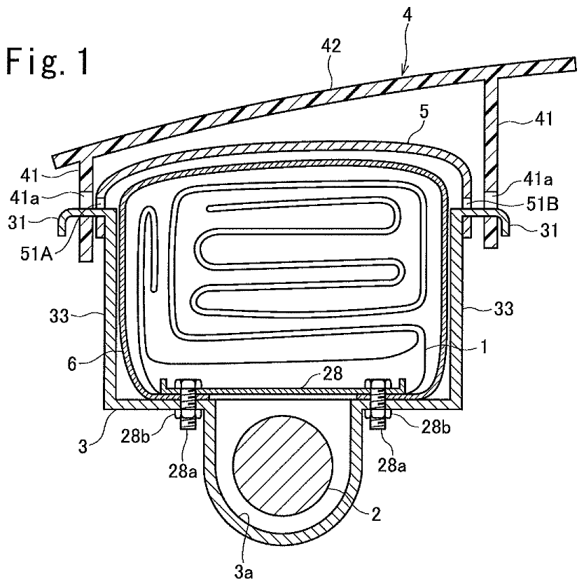

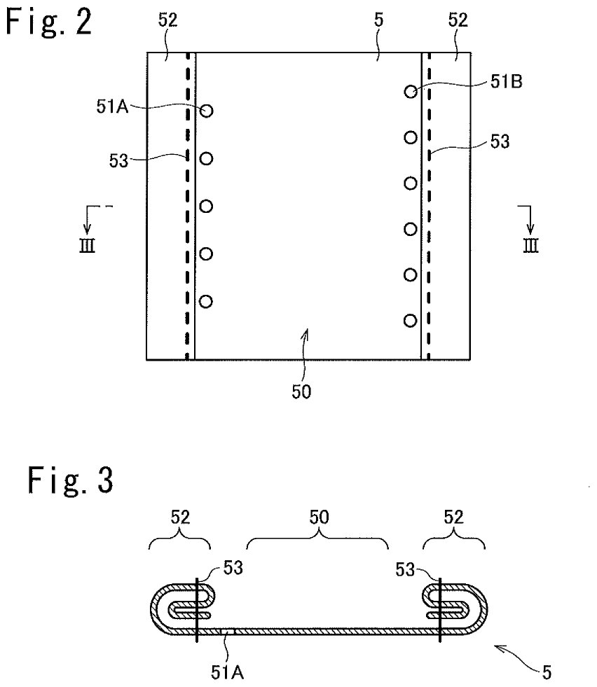

Hereinafter an embodiment will be described with reference to the drawings. FIG. 1 is a cross-sectional view illustrating an airbag device according to an embodiment of the present invention. FIG. 2 is a plan view of a first protector cloth used in the airbag device. FIG. 3 is a vertical cross-sectional view of the first protector cloth taken along line III-III of FIG. 2.

The airbag device according to the embodiment of the present invention has an airbag 1 that is folded in normal times and is inflated and deployed in emergency situations; an inflator 2 that supplies a gas to the airbag 1; a retainer 3 that supports the airbag 1 and the inflator 2; and a module cover 4 that covers the airbag 1.

Multiple hooks 31 formed on the retainer 3 are retained in multiple openings 41a formed in side wall sections 41 of the module cover 4. The folded shape of the airbag 1 is maintained by a first protector cloth 5 and a second protector cloth 6.

The first protector cloth 5 has a central section 50 that covers the upper surface of the folded body of the airbag 1, and multiple openings 51A, 51B that are disposed on both sides of the central section 50 and inserted in the hooks 31.

The airbag device is, for example, an airbag device for a passenger seat, and is installed in an instrument panel (not illustrated) disposed in front of the passenger seat. A plate-like section 42 of the module cover 4 that covers the airbag 1 constitutes part of the instrument panel. When a gas is supplied to the inside by an operation of the inflator 2, the airbag 1 starts to be inflated and deployed, causes the plate-like section 42 of the module cover 4 to be teared, is released into the vehicle cabin, and is inflated and deployed in front of a passenger seated on the passenger seat.

The base end side of the airbag 1 is provided with an opening for introduction (symbol is omitted) for introducing a gas from the inflator 2, and the circumferential portion of the opening is fixed to the retainer 3 by a fixing member 28. The inflator 2 is a gas generator that generates a gas to be supplied to the airbag 1, and has an approximately cylindrical outer shape, for example.

The retainer 3 is an approximately rectangular parallelepiped container-like object with the upper side open in this embodiment. The bottom surface of the retainer 3 is provided with an inflator disposition section 3a which is a recess, and the inflator 2 is installed in the disposition section 3a.

The retainer 3 is a member that supports the airbag 1 and the inflator 2, and is configured to be connectable to the module cover 4. The hooks 31 are each disposed at a position on wall surfaces 33 which surround the outer circumference of the retainer 3, the position corresponding to an opening 41a of the module cover 4. In general, it is often the case that the hooks 31 are disposed on the wall surfaces 33 disposed in the front-rear direction of a vehicle body. Also, when the retainer 3 is made of metal, the hooks 31 may be connected to the retainer 3 by welding, or when the retainer 3 is made of resin, the hooks 31 may be integrally formed with resin.

The hooks 31 are provided so as to project to the outside, on the upper portion of the wall surfaces 33 standing from the circumferential edge of the bottom surface of the retainer 3. The number of the hooks 31 provided on the wall surface 33 on the vehicle front side is greater than the number of the hooks 31 provided on the wall surface 33 on the vehicle rear side.

When the airbag 1 is mounted on the retainer 3, the circumferential edge portion of the above-mentioned opening for gas introduction is overlapped on the circumferential edge portion of the inflator disposition section 3a and is pressed by a fixing member (bag ring) 28. At that point, stud bolts 28a provided projecting from the fixing member 28 penetrate the circumferential edge portion of the opening for gas introduction and the bottom surface of the retainer 3, and project downward of the retainer 3. The circumferential edge portion of the opening for gas introduction and the fixing member 28 are fixed to the bottom surface of the retainer 3 by securing a nut 28b to each stud bolt 28a. It is to be noted that the fixing member 28 is provided with an air hole (symbol is omitted), and a gas from the inflator 2 is introduced into the airbag 1 through the air hole.

The module cover 4 has the plate-like section 42 that constitutes part of the instrument panel, and the side wall sections 41 provided upright inwardly of the plate-like section 42. The side wall sections 41 may be formed in a cylindrical shape so as to cover the entire circumference of the airbag 1, or may be formed of four plate members disposed so as to cover only the front, rear, right, and left of the airbag 1. Alternatively, the side wall sections 41 may be injection-molded together with the plate-like section 42, or may be connected to the plate-like section 42 by vibration welding or the like. Also, in the front and rear side wall sections disposed in the front-rear direction of the vehicle body among the side wall sections 41 in the front, rear, right and left, multiple openings 41a arranged in the right-left direction are formed.

The first protector cloth 5 and the second protector cloth 6 have a function of maintaining the folded shape of the airbag 1 by covering the surface of the folded airbag 1 as well as a function of assisting smooth inflation and deployment of the airbag 1. The first protector cloth 5 and the second protector cloth 6 are parts referred to as a protector sheet, a packing cloth, a packing sheet, etc., and is composed of a base fabric which is the same material as that of the airbag 1.

Although illustration is omitted, the second protector cloth 6 has an approximately rectangular outer shape, and both ends thereof are provided with a retainer hole in which a stud bolt 28a is insertable. Both ends of the second protector cloth 6 are fixed to the bottom surface of the retainer 3 along with the airbag 1. A perforation-like tear line is formed at approximately the central portion of the second protector cloth 6.

As illustrated in FIG. 2, the first protector cloth 5 has an approximately rectangular outer shape, and both sides of the central section 50 are provided with retaining holes 51A, 51B in which the hooks 31 are insertable. The central section 50 is a section that covers the upper surface of the folded body of the airbag 1 with the second protector cloth 6 interposed therebetween, and a perforation-like tear line (illustration is omitted) is formed at approximately the central portion.

The hooks 31 (the hooks on the left side of FIG. 1) provided on the wall surface 33 on the vehicle rear side (the passenger seat side) of the retainer 3 are each inserted in a retaining hole 51A. The hooks 31 (the hooks on the right side of FIG. 1) provided on the wall surface 33 on the vehicle front side of the retainer 3 are each inserted in a retaining hole 51B. In this embodiment, the number of the retaining holes 51B is greater than the number of the retaining holes 51A, and in the example illustrated in FIG. 2, five retaining holes 51A and six retaining holes 51B are provided. The number of the retaining holes 51A and the number of the retaining holes 51B are not limited to these. The retaining holes 51A and the retaining holes 51B may be equivalent in number, or the number of the retaining holes 51A may be greater than the number of the retaining holes 51B.

Both ends 52 (closer to end side than the retaining holes 51A, 51B) of the first protector cloth 5 are folded and stitched by a stitching thread 53, thereby being multiply formed. In the example illustrated in FIG. 3, the both ends 52 are quadruply formed. The retaining holes 51A, 51B are located closer to the central side than a section stitched by the stitching thread 53.

When the airbag 1 is inflated and deployed, the first protector cloth 5 and the second protector cloth 6 are teared along the tear line, and the airbag 1 is released.

When the airbag device is assembled, the airbag 1 is first folded in a desired shape. The fixing member 28 is internally disposed in the opening for gas introduction of the airbag 1, and the stud bolts 28a are inserted in openings provided in the surroundings of the opening for gas introduction. After the airbag 1 is folded, the stud bolts 28a are inserted in the retaining holes of the second protector cloth 6, and the folded body of the airbag 1 is enveloped by the second protector cloth 6.

Next, the airbag folded body is housed in the retainer 3 in which the inflator is disposed, the stud bolts 28a are inserted in the insertion holes provided in the bottom surface of the retainer 3, and the nut 28b is secured to each stud bolt 28a. Thus, the circumferential edge portion of the opening for gas introduction of the airbag 1 and the both ends of the second protector cloth 6 are fixed to the bottom surface of the retainer 3.

Next, the hooks 31 of the retainer 3 are inserted in the retaining holes 51A, 51B of the first protector cloth 5. Thus, the first protector cloth 5 presses the airbag folded body from above. It is preferable that the first protector cloth 5 be mounted so that a non-coated surface of the first protector cloth 5 faces downward, in other words, faces the second protector cloth 6, and a coated surface faces upward.

Subsequently, the hooks 31 are inserted in the openings 41a of the module cover 4, and thus the airbag device is completed.

According to the embodiment, the first protector cloth 5 that covers the airbag folded body is retained in a great number of hooks 31 provided on the retainer 3. The number of the hooks 31 is greater than the number of the stud bolts 28a by which the second protector cloth 6 is retained. Thus, it is possible to firmly fix the first protector cloth 5 to the retainer 3 and to maintain the folded shape of the airbag 1.

Also, after the airbag shape is fixed, the performance of the airbag 1, such as a deployment speed and an internal pressure, can be adjusted by changing the shape of the first protector cloth 5.

In the embodiment described above, the configuration has been described in which the folded body of the airbag 1 is covered using the first protector cloth 5 and the second protector cloth 6. However, the second protector cloth 6 may not be used.

It is to be noted that the present invention is not limited to the above-described embodiment as it is, and in the stage of implementation, the components may be modified and embodied without departing from the essence of the invention. Also, various types of invention can be implemented by an appropriate combination of multiple components disclosed in the embodiment. For example, some components may be deleted from the entire components presented in the embodiment. In addition, components in different embodiments may be combined as needed.

1. An airbag device, comprising:
an airbag that is folded in normal times and is inflated and deployed in emergency situations;
an inflator that supplies a gas to the airbag;
a retainer that supports the airbag and the inflator;
a module cover that has a plate-like section and a side wall section provided upright on the plate-like section, wherein a hook formed on the retainer is retained in an opening formed in the side wall section; and
a first protector cloth that is retained in the hook, and covers an upper surface of a folded body of the airbag to maintain a folded shape of the airbag.

2. The airbag device according to claim 1, further comprising
a second protector cloth that has both ends fixed to a bottom surface of the retainer along with the airbag, and envelops the folded body of the airbag to maintain the folded shape.
